(19) United States
(12) Patent Application Publication
(10) Pub. No.: US 2025/0060000 A1
(43) Pub. Date: Feb. 20, 2025

(54) RIVET NUT, RIVET NUT ASSEMBLY SYSTEM, AND RIVET NUT ASSEMBLY METHOD

(71) Applicants: HYUNDAI MOTOR COMPANY, Seoul (KR); KIA CORPORATION, Seoul (KR); PUNGKANG CO., LTD., Hwaseong-si (KR)

(72) Inventors: Wan-Woo Park, Seongnam-si (KR); Tae-Young Han, Hwaseong-si (KR)

(73) Assignees: HYUNDAI MOTOR COMPANY, Seoul (KR); KIA CORPORATION, Seoul (KR); PUNGKANG CO., LTD., Hwaseong-si (KR)

(21) Appl. No.: 18/516,017

(22) Filed: Nov. 21, 2023

(30) Foreign Application Priority Data
Aug. 18, 2023 (KR) 10-2023-0107987

(51) Int. Cl. F16B 37/06; B23P 19/06

(52) U.S. Cl. CPC F16B 37/067; B23P 19/063

(57) ABSTRACT

A rivet nut has a through-hole and a target member is assembled with the rivet nut passing therethrough. The rivet nut includes a cylindrical body, a protrusion formed on and protruding from a lower end of the cylindrical body, and a flange formed on and protruding from an upper end of the cylindrical body. The target member is assembled by the flange contacting an upper-end surface of the target member and the protrusion contacting a lower-end surface of the target member.

### CROSS-REFERENCE TO RELATED APPLICATION

This application claims priority to Korean Patent Application No. 10-2023-0107987, filed on Aug. 18, 2022, which is incorporated herein by reference in its entirety.

### BACKGROUND

### Field of the Disclosure

The present disclosure relates to a rivet nut for joining components to each other and to a system and a method for assembling the components.

### Description of Related Art

Rivet nuts are fasteners used for assembling target members, such as plates and tubular members, to manufacture a component. The rivet nut passes through a hole in the target member and a bolt fastened to another target member is screwed into a threaded inner surface of the river nut. Thus, the two target members are assembled or coupled to one another.

When the rivet nut is used, for example, for a tubular member in the related art, only one surface of the tubular member is fixed or coupled to the rivet nut. Thus, it is impossible to secure or couple both surfaces of the tubular member to the rivet nut.

In other words, when using riveting technology, due to limitations in a tubular component manufacturing process, it is not possible to manufacture a dome capable of deforming a riveting portion pilot so as to join the rivet nut and the tubular component. Consequently, joining of the rivet nut and the tubular member is impossible.

In addition, when using clenching technology, material deformation is difficult due to limitations in high-strength steel. Consequently, joining is impossible.

The subject matter described above is intended to enhance understanding of the background of the present disclosure. Thus, the above may include subject matter that, although not referred to as the related art, is known to a person of ordinary skill in the art to which the present disclosure pertains.

### SUMMARY

Objects of the present disclosure, which is contrived to find a solution to the above-mentioned problems, are to provide a rivet nut, a rivet nut assembly system, and a rivet nut assembly method that are capable of securing or coupling both upper and lower surfaces of a target member during assembly, thereby compensating for tolerance in dimensions of the upper and lower surfaces and performing assembling without the need for machining a conical protrusion (dome).

According to an aspect of the present disclosure, a rivet nut is provided in which a through-hole is formed. A target member is assembled with the rivet nut passing therethrough. The rivet nut includes: a cylindrical body; a protrusion formed on and protruding axially from a lower end of the cylindrical body; and a flange formed on and protruding radially from an upper end of the cylindrical body. The target member and the rivet nut are assembled by the flange contacting an upper-end surface of the target member and the protrusion contacting a lower-end surface of the target member.

The rivet nut may further include a plurality of lower-end ribs protruding from a lower-end surface of the cylindrical body and an outer surface of the protrusion. When the target member and the rivet nut are assembled by the protrusion contacting the lower-end surface of the target member, the plurality of lower-end ribs may press against the lower-end surface of the target member.

In the rivet nut, a rivet may be formed on an upper end portion of the cylindrical body having a diameter that is greater than a diameter of the cylindrical body, but smaller than a diameter of the flange.

The rivet nut may further include a plurality of upper-end ribs protruding from a lower-end surface of the flange and an outer surface of the cylindrical body.

In the rivet nut, the flange may be formed in a manner that covers the through-hole.

In rivet nut, a sealing substance may be applied to a lower-end surface of the flange and an outer surface of an upper end portion of the cylindrical body.

According to another aspect of the present disclosure, a rivet nut assembly system is provided and includes: the rivet nut; a fixation tool for supporting a lower end portion of the rivet nut; and a punching tool for pressing against an upper end portion of the rivet nut.

In the rivet nut assembly system, the fixation tool may include a body and a groove. The protrusion of the rivet nut may seat in the groove, and the groove may have a shape of a ring in an upper-end surface of the body.

In the rivet nut assembly system, a tool protrusion may be formed on and protrude from the upper-end surface of the body fixation tool adjacent to and radially inward of the groove.

In the rivet nut assembly system, the tool protrusion may have an inclined outer surface such that the tool protrusion has a diameter that gets smaller toward an upper end thereof.

In the rivet nut assembly system, the punching tool may press against the rivet nut in a state where the fixation tool supports a lower surface of the target member. The protrusion may be deformed in a bent manner along the inclined outer surface of the tool protrusion. Thus, the target member may be assembled by the tool protrusion contacting the lower-end surface of the target member.

In the rivet nut assembly system, a body of the fixation tool may be configured to have a lower cylindrical sub-body and an upper conical sub-body.

In the rivet nut assembly system, the punching tool may include a body and a lower-end groove. The flange of the rivet nut may be received in the lower-end groove, and the lower-end groove may be in a lower-end surface of the body of the punching tool.

The rivet nut assembly system may further include a first deformation prevention support insertable into the target member. An upper surface thereof may be configured to contact a lower surface of an upper end portion of the target member. A lower surface thereof may be configured to contact an upper surface of a lower end portion of the target member. A first-through groove may be formed in one side of the first deformation prevention support in a manner that extends there along from top to bottom. The system may also include a second deformation prevention support insertable into the target member. An upper surface thereof may be configured to contact the lower surface of the upper end portion of the target member. A lower surface thereof may be configured to contact the upper surface of the lower end portion of the target member. A second through-groove may be formed in an opposite side of the second deformation prevention support, configured to face the one side of the first deformation prevention support, and in a manner that extends there along from top to bottom. The target member may have a tubular shape.

According to still another aspect of the present disclosure, a rivet nut assembly method is provided. The method includes: arranging the inclined outer surface of the tool protrusion of the fixation tool in such a manner as to be inserted into a lower-end hole formed in the lower end portion of the target member; arranging the rivet nut by being inserted through an upper-end hole formed in the upper end portion of the target member in such a manner that the protrusion is seated in the groove in the fixation tool; and pressing against an upper-end surface of the rivet nut by pushing down the punching tool.

In the rivet nut assembly method, in pressing against the upper-end surface of the rivet nut, the fixation tool may press against a lower-end surface of the target member, deforming the protrusion in a bent manner along the inclined outer surface of the tool protrusion. Thus, the target member may be assembled by the protrusion contacting the lower-end surface of the target member and the flange contacting the upper-end surface of the target member.

In the rivet nut assembly method, the rivet nut may include a plurality of lower-end ribs protruding from a lower-end surface of the cylindrical body and an outer surface of the protrusion. In pressing against the upper-end surface of the rivet nut, the lower-end ribs deform the lower-end surface of the target member by pressing there against.

The rivet nut assembly method may further include, before pressing again the upper-end surface of the rivet nut, inserting the first deformation prevention support and the second deformation prevention support into the target member in such a manner that the first through-groove in the first deformation prevention support and the second through-groove in the second deformation prevention support face each other.

According to the present disclosure, it is possible to assemble the target member in such a manner that both surfaces thereof are secured or coupled to the nut rivet. In addition, by providing an additional constituent element, resistance against twisting and pressure between the rivet nut and a component can be achieved after the joining is performed. Moreover, the joining can be performed while compensating for tolerance in dimensions without the need for machining a dome.

The rivet nut has a watertight structure. A sealing paint or substance is applied to the rivet nut. Thus, moisture penetration can be prevented.

### BRIEF DESCRIPTION OF THE DRAWINGS

FIG. 1 is a perspective view illustrating a rivet nut according to a first embodiment of the present disclosure.

FIG. 2 is a front view illustrating the rivet net in FIG. 1.

FIG. 3 is a cross-sectional view illustrating the rivet nut in FIG. 1.

FIG. 4 is a perspective view illustrating one portion of a rivet nut assembly system including the rivet nut according to the first embodiment of the present disclosure.

FIG. 5 is a cross-sectional view illustrating the system in FIG. 4.

FIG. 6 is a cross-sectional view illustrating the post-assembling rivet nut.

FIG. 7 is a view illustrating a process of assembling with the rivet nut according to the first embodiment of the present disclosure.

FIG. 8 is a partially enlarged view illustrating a circular portion A of FIG. 7.

FIG. 9 is a partially enlarged view illustrating the post-deformation circular portion A of FIG. 7.

FIG. 10 is a view illustrating a fixation tool that is one constituent element of the rivet nut assembly system including the rivet nut according to the first embodiment of the present disclosure.

FIG. 11 is a cross-sectional view illustrating the fixation tool in FIG. 10.

FIG. 12 is a partially enlarged view illustrating the fixation tool in FIG. 10.

FIG. 13 is a punching tool that is one constituent element of the rivet nut assembly system including the rivet nut according to the first embodiment of the present disclosure.

FIG. 14 is a cross-sectional view illustrating the punching tool in FIG. 13.

FIG. 15 is a view illustrating a state where a deformation prevention support, which is one constituent element of the rivet nut assembly system including the rivet nut according to the first embodiment of the present disclosure, does not yet operate.

FIG. 16 is a view illustrating a state where the deformation prevention support, which is one constituent element of the rivet nut assembly system including the rivet nut according to the first embodiment of the present disclosure, finishes its operation.

FIG. 17 is a perspective view illustrating a rivet nut according to a second embodiment of the present disclosure.

FIG. 18 is a front view illustrating the rivet nut in FIG. 17.

FIG. 19 is a cross-sectional view illustrating the rivet nut in FIG. 17.

FIG. 20 is a view illustrating a deformation prevention support, which is one constituent element of a rivet nut assembly system including the rivet nut according to the second embodiment of the present disclosure.

FIG. 21 is a perspective view illustrating a rivet nut according to a third embodiment of the present disclosure.

FIG. 22 is a front view illustrating the rivet nut in FIG. 21

FIG. 23 is a perspective view illustrating a rivet nut according to a fourth embodiment of the present disclosure.

FIG. 24 is a cross-sectional view illustrating the rivet nut in FIG. 23.

FIG. 25 is a partially enlarged view illustrating the rivet nut in FIG. 23.

### DESCRIPTION OF SPECIFIC EMBODIMENTS

To gain a comprehensive understanding of the present disclosure, its operational advantages, and objects accomplished by the embodiments, reference should be made to the accompanying drawings in which embodiments of the disclosure are illustrated.

Where a description of a well-known technology associated with the embodiments of the present disclosure would have made the nature and gist of the present disclosure unnecessarily obfuscated, a description thereof has been shortened or omitted. When a component, device, element, or the like of the present disclosure is described as having a purpose or performing an operation, function, or the like, the component, device, or element, should be considered herein as being “configured to” meet that purpose or perform that operation or function.

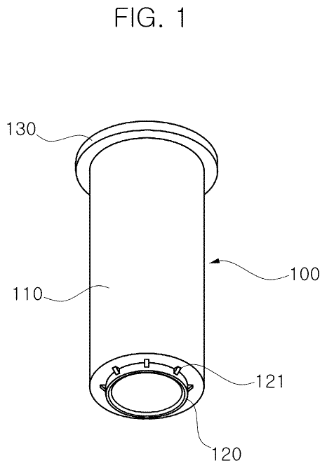

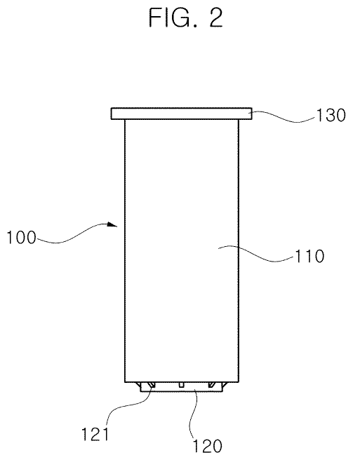

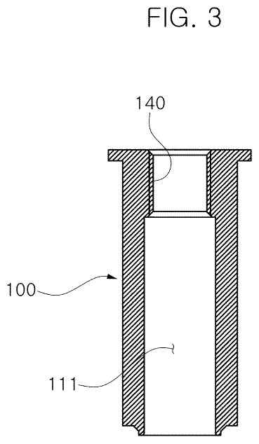

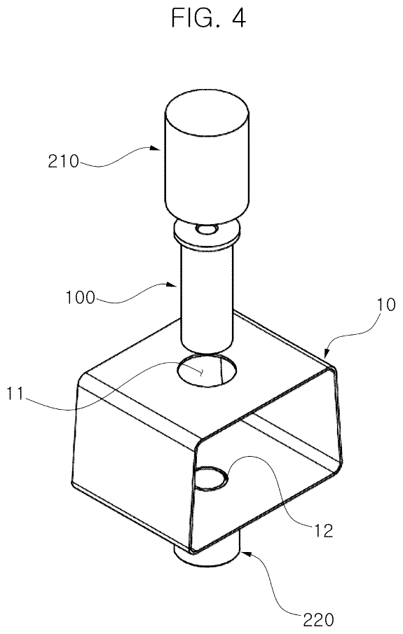

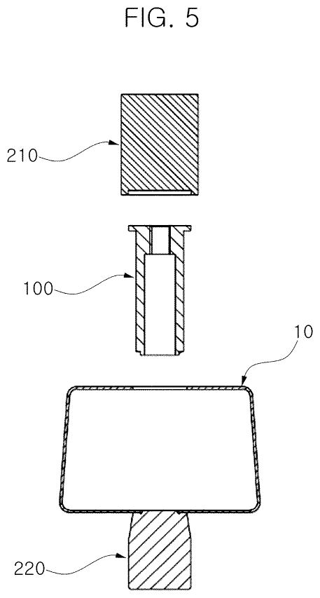

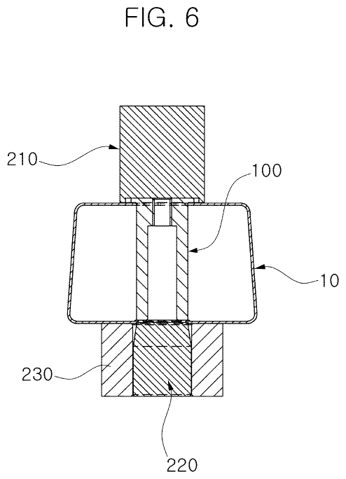

FIG. 1 is a perspective view illustrating a rivet nut according to a first embodiment of the present disclosure. FIG. 2 is a front view illustrating the rivet nut in FIG. 1. FIG. 3 is a cross-sectional view illustrating the rivet nut in FIG. 1. FIG. 4 is a perspective view illustrating one portion of a rivet nut assembly system including the rivet nut according to the first embodiment of the present disclosure. FIG. 5 is a cross-sectional view illustrating the system in FIG. 4. FIG. 6 is a cross-sectional view illustrating a state in which an assembling process is completed.

The rivet nut according to the first embodiment of the present disclosure, the rivet nut assembly system including the rivet nut according to the first embodiment of the present disclosure, and a rivet nut assembly method that uses the rivet nut assembly system are described below with reference to FIGS. 1-4.

A rivet nut 100 according to the first embodiment of the present disclosure is a fastener with or through which a target member, such as a tubular member 10 illustrated or a plate, can be assembled to a different member or element. The rivet nut 100 may be coupled to the target member 100. The rivet nut 100 passes through the target member and a bolt fastened to the different member is engaged with a threaded portion 140 formed on an inner surface of the rivet nut 100. Thus, the two members are assembled to manufacture a component, device, or apparatus.

In some examples, the target member is a tubular shaped member that can withstand a high tension force. For example, the target member may be a pipe shaped member with a circular or polygonal cross section that has a strength of 600 MPa or higher. The target member may comprise a vehicular pillar and the rivet nut 100 may be used to fasten a safety belt module to the vehicle pillar.

The rivet nut assembly system may include a fixation tool 220 for supporting a lower end portion of the rivet nut 100, a punching tool 210 for pressing against an upper end portion of the rivet nut 100, and a deformation prevention support for preventing deformation of the target member when the punching tool 210 presses against the upper end portion of the rivet nut 100. Moreover, the fixation tool 220 may be configured to have a tool support portion 230 that surrounds the fixation tool 220 for support (See FIG. 6).

The rivet nut 100 includes a hollow cylindrical body 110 in which a through-hole 111 is formed and on which a protrusion 120 and a flange 130 are formed. The threaded portion 140 is formed on an inner surface of the through-hole 111. The protrusion 120 is formed on and protrudes axially from a lower end of the cylindrical body 110. The flange 130 is formed on and protrudes radially from an upper end of the cylindrical body 110.

A bolt for fastening members, such as the target member and another member, to each other is inserted into the through-hole 111, thereby being engaged with the threaded portion 140.

A hole is formed in the target member in such a manner that the rivet nut 100 passes through the hole. As illustrated, an upper-end hole 11 and a lower-end hole 12 are formed in upper and lower end portions, respectively, of the tubular member 10. The cylindrical body 110 has an outer diameter that corresponds to a diameter of the upper-end hole 11.

The protrusion 120 may be cylindrically formed on the lower end of the cylindrical body 110 in such a manner as to have an inner diameter that corresponds to a diameter of the through-hole 111. Alternatively, the protrusion 120 may be formed along a circumference of the lower end portion in a manner that partially protrudes therefrom.

As described below, the protrusion 120 is deformed when the punching tool 210 presses against the upper end portion of the rivet nut 100, and thus is joined to a lower-end surface of the target member. Specifically, the protrusion 120 may be deformed as it contacts the fixation tool 220.

A plurality of lower-end ribs 121 are formed circumferentially on a lower-end surface of the cylindrical body 110 and an outer surface of the protrusion 120 in such a manner as to protrude therefrom and to partially connect with or contact each of the lower-end surface of the cylindrical body 110 and the outer surface of the protrusion 120.

Therefore, during assembly, the lower-end surface of the target member is deformed by the lower-end ribs 121 and is joined to the lower-end surface of the cylindrical body 110. The plurality of lower-end ribs 121 disposed circumferentially around the protrusion 120 make the rivet nut 100 resistant to rotation or prevent the rivet nut 100 from rotating relative to the target member.

The flange 130 formed on the upper end of cylindrical body 110 is arranged over an upper-end surface of the target member, for example, the tubular member 10 illustrated. When the punching tool 210 presses against the upper end portion of the rivet nut 100, the flange 130 is joined to the upper-end surface of the tubular member 10 by coming into contact therewith.

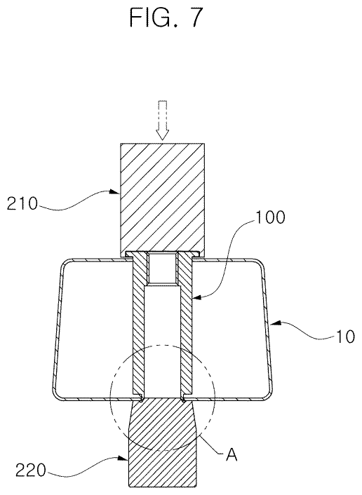

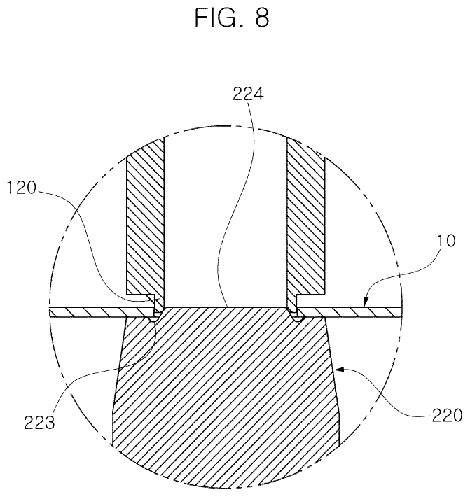

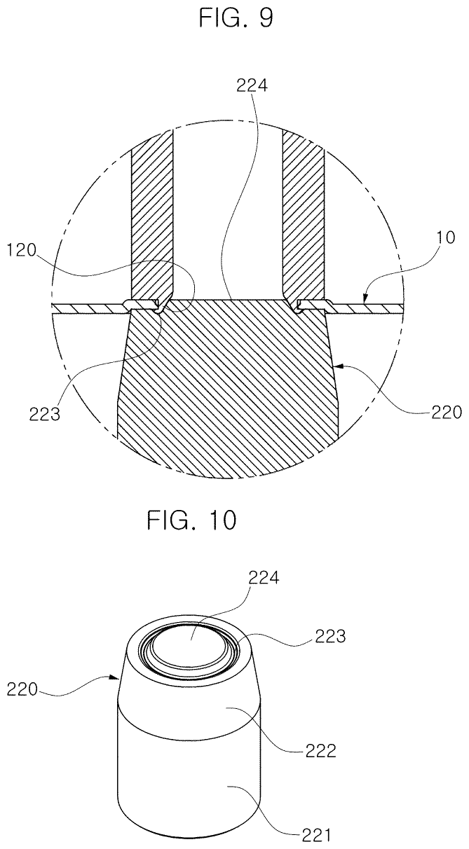

FIG. 7 is a view illustrating a process of assembling with the rivet nut according to the first embodiment of the present disclosure. FIG. 8 is a partially enlarged view illustrating a circular portion A of FIG. 7. FIG. 9 is a partially enlarged view illustrating the circular portion A of FIG. 7 that results after assembling.

First, the fixation tool 220 is arranged under the lower-end hole 12 in the target member, for example, the tubular member 10. The rivet nut 100 is then inserted into the tubular member 10 through the upper-end hole 11 and is arranged on the top of the fixation tool 220.

Then, as illustrated in FIG. 7, when the punching tool 210 presses against an upper-end surface of the rivet nut 100, the protrusion 120 of the rivet nut 100 is deformed. Thus protrusion 120 is joined to a lower-end surface of the tubular member 10 and the flange 130 of the rivet nut 100 is joined to the upper-end surface of the target or tubular member 10.

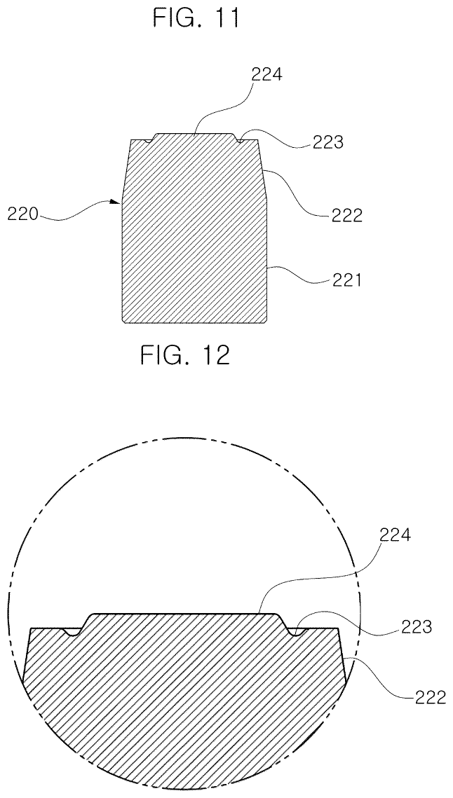

With reference to FIGS. 10-12, a body of the fixation tool 220 is configured to have a lower cylindrical sub-body 221 and an upper conical sub-body 222. An upper-end surface of the cylindrical sub-body 221 and the lower surface of the conical sub-body 222 are on the same plane.

Since the conical sub-body 222 is an upper portion of the fixation tool 220, the tubular member 10 and the fixation tool 220 can be easily separated from each other after the punching tool 210 presses against the upper end portion of the rivet nut 100.

A groove 223 is formed in the shape of a ring at a position on an upper-end surface of the conical sub-body 222 that faces the protrusion 120 of the rivet nut 100. As illustrated in FIG. 8, the protrusion 120 of the rivet nut 100 is seated in the groove 223 before the punching tool 210 presses against the upper end portion of the rivet nut 100. Therefore, the protrusion 120 also has an outer diameter that is equal to or smaller than an inner diameter of the lower-end hole 12 in the target or tubular member 10.

Moreover, a tool protrusion is formed inside the groove 223 in a manner that protrudes from the upper-end surface of the conical sub-body 222. In some examples, the tool protrusion is formed to be an inclination protrusion or surface 224 that has a diameter that gets smaller toward an upper end thereof. In other words, in some examples, the tool protrusion may be formed to have an inclined outer surface such that the tool protrusion has a diameter that gets smaller toward an upper end thereof.

In other words, when the punching tool 210 presses against the upper end portion of the rivet nut 100 in a state as illustrated in FIG. 8 when a pressing operation is not yet performed, the protrusion 120 of the rivet nut 100, as illustrated in FIG. 9, is deformed in a bent manner along the outer surface of the tool protrusion, for example, inclination protrusion or surface 224. As illustrated in FIG. 9, when the fixation tool 220 pushes up the lower surface of the target or tubular member 10, a portion (e.g., a first portion) of the protrusion 120 that is adjacent to the inside of the lower-end hole 12 in the tubular member is also deformed. Thus, the portion (e.g., a first portion) thereof is pressed into a space between the target or tubular member 10 and the rivet nut 100, thereby eliminating the space.

Thus, the groove 223 also serves to regulate a shape of the protrusion 120 and a distance which the protrusion 120 extends when the protrusion 120 is deformed.

Accordingly, the tool protrusion forms a dome that cannot be otherwise formed by another manufacturing process due to its characteristics. This formation can compensate for a possible tolerance in a distance between the upper and lower surfaces thereof.

In this manner, the lower end portion of the rivet nut 100 is coupled to the lower-end surface of the tubular member 10 by the protrusion 120 and the lower end ribs 121. The lower-end ribs 121 deform the lower-end surface of the tubular member 10, and thus the rivet nut 100 is made to be resistant to its rotation. The lower-end ribs 121 may deform the lower end surface of the tubular member, preventing the rivet nut 100 from rotating relative to the tubular member 10. In addition, after this deformation occurs, the fixation tool 220 is easily separated due to an inclined surface of the inclination protrusion 224.

Therefore, a greater fixation force can be generated than when using a rivet nut or a clinch nut in the related art to which only one surface of a target member can be joined.

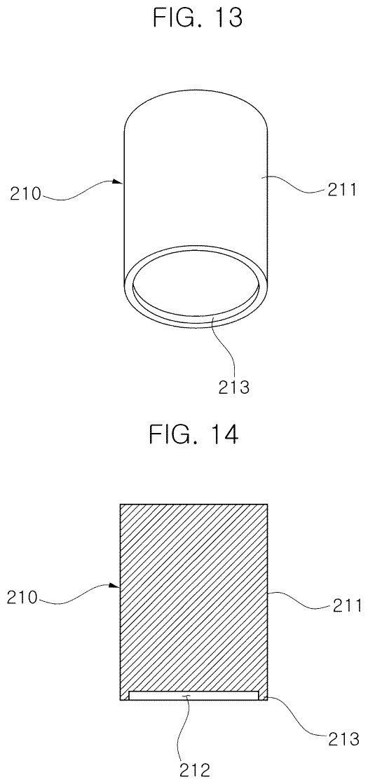

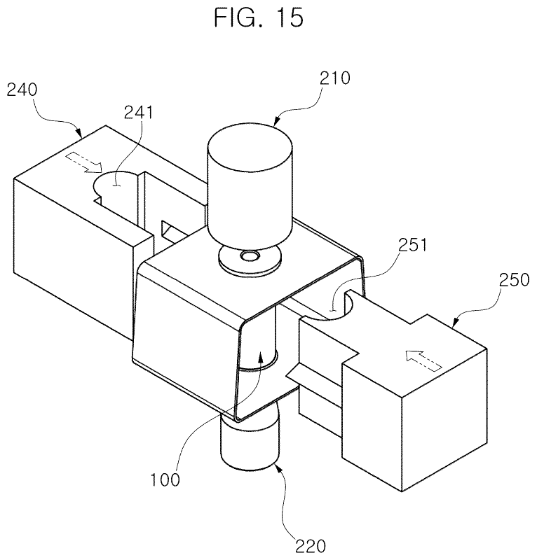

Next, with reference to FIGS. 13 and 14, the punching tool 210 is configured to have a cylindrical body 211. A lower-end groove 212 is formed in the lower-end surface of the cylindrical body 211, resulting in forming a protruding circumferential portion 213.

As illustrated in FIGS. 6 and 7, the lower-end groove 212 has an inner diameter equal to or greater than an outer diameter of the flange 130 of the rivet nut 100. As illustrated in FIG. 7, the punching tool 210 is arranged in such a manner that the flange 130 is inserted into the lower-end groove 212. Then, the punching tool 210 descends by a punching tool drive apparatus, thereby pressing against the rivet nut 100.

To this end, in some examples, the protruding circumferential portion 213 has a smaller height than the flange 130.

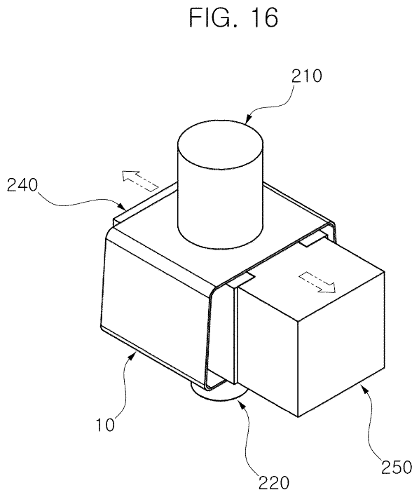

Then, with reference to FIGS. 15 and 16, the deformation prevention support of the rivet nut assembly system includes a first deformation prevention support 240 and a second deformation prevention support 250.

The first deformation prevention support 240 is insertable into the target or tubular member 10. The first deformation prevention support 240 is configured in such a manner that an upper surface thereof is configured to contact a lower surface of an upper end portion of the target member or tubular member 10, and that a lower surface thereof is configured to contact an upper surface of a lower end portion of the target or tubular member 10. A first through-groove 241 is formed in one side of the first deformation prevention support 240 in a manner that passes there along from top to bottom.

The second deformation prevention support 250 is also insertable into the tubular member 10. The second deformation prevention support 250 is configured in such a manner that an upper surface thereof is configured to contact the lower surface of the upper end portion of the tubular member 10, and that a lower surface thereof is configured to contact the upper surface of the lower end portion of the tubular member 10. A second through-groove 251 is formed in an other side of the second deformation prevention support 250, facing the one side of the first deformation support 24 in a manner that passes therefrom from top to bottom.

Accordingly, as illustrated in FIG. 16, when the first deformation prevention support 240 and the second deformation prevention support 250 are inserted in the target or tubular member 10 in such a manner as to face each other, the first through-groove 241 and the second through-groove 251 may be arranged in such a manner as to surround the cylindrical body 110 of the rivet nut 100.

In this state, when the punching tool 210 presses against the upper end portion of the rivet nut 100, the deformation prevention support prevents the tubular member 10 from being deformed.

As illustrated, the first deformation prevention support 240 and the second deformation prevention support 250 have female and male forms, respectively, and thus can be coupled to each other. However, as long as they have the configuration and function as described above, they are not required to have these female and male forms.

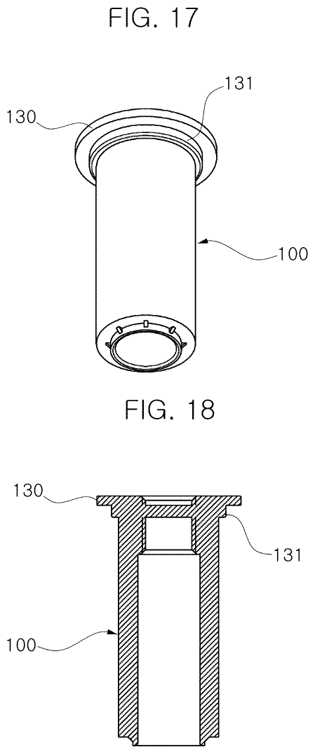

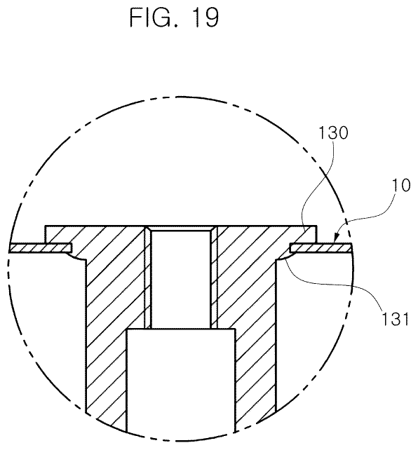

Next, FIG. 17 is a perspective view illustrating a rivet nut 100 according to a second embodiment of the present disclosure. FIG. 18 is a front view illustrating the rivet nut 100 in FIG. 17. FIG. 19 is a cross-sectional view illustrating the rivet nut 100 in FIG. 17.

The rivet nut 100 in FIG. 17 according to the second embodiment results from adding a cylindrical rivet 131 to the rivet nut 100 according to the first embodiment of the present disclosure. The cylindrical rivet 131 has a diameter that is greater than that of the cylindrical body 110, but smaller than that of the flange 130. The cylindrical rivet 131 is provided or formed in an upper end portion of the cylindrical body 110.

As illustrated in FIG. 19, with the rivet 131, the rivet nut 100 according to the second embodiment of the present disclosure can be coupled to the upper-end surface of the target member or tubular member 10 with a greater fixation force by being pressed thereto.

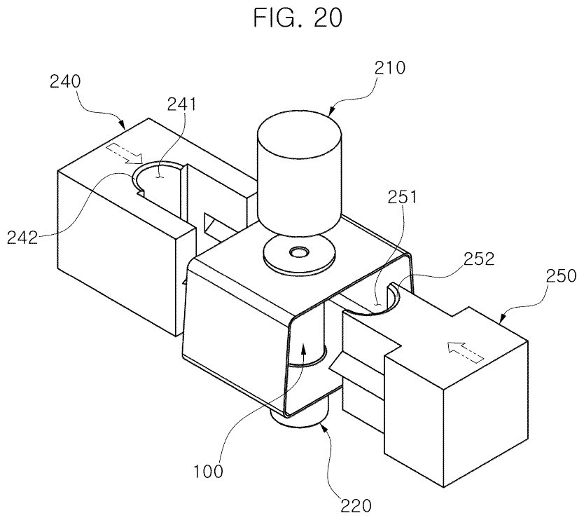

When the rivet nut 100 according to the second embodiment of the present disclosure is used, as illustrated in FIG. 20, a first stepped groove 242 may be formed in an upper surface of the first deformation prevention support 240 that is adjacent to an upper end portion of the first through-groove 241 in the first deformation prevention support 240. A second stepped groove 252 may be formed in an upper surface of the second deformation prevention support 250 that is adjacent to an upper end portion of the second through-groove 251 in the second deformation prevention support 250.

Therefore, the rivet 131 of the rivet nut 100 is not blocked by the first and second deformation prevention supports 240 and 250.

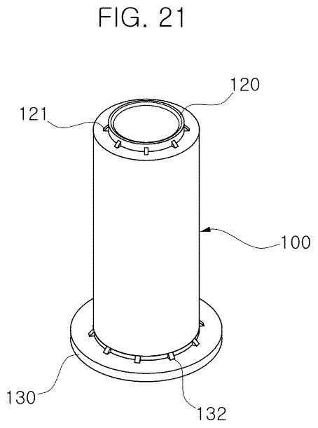

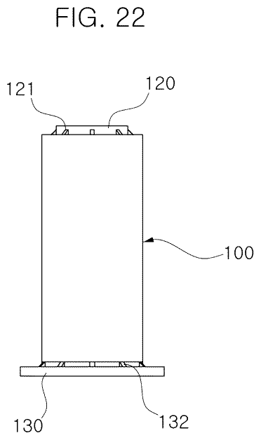

FIG. 21 is a perspective view illustrating a rivet nut 100 according to a third embodiment of the present disclosure. FIG. 22 is a front view illustrating the rivet nut 100 in FIG. 21.

The rivet nut 100 in FIG. 21 according to the third embodiment of the present disclosure results from adding an upper-end rib 132 to the rivet nut 100 according to the first or second embodiment of the present disclosure.

A plurality of upper-end ribs 132 are circumferentially disposed between a lower-end surface of the flange 130 and an outer surface of the cylindrical body 110 in such a manner as to protrude therefrom and to partially connect with or contact each of the lower-end surface of flange 130 and the outer surface of the cylindrical body 110. The plurality of upper-end ribs 132 may protrude from the lower-end surface of the flange 130 and an outer surface of the cylindrical body.

Therefore, during assembly, the upper-end surface of the target member is deformed by the upper-end ribs 132 and is joined to the upper-end surface of the target member. The plurality of upper-end ribs 132 formed circumferentially make the rivet nut 100 resistant to its rotation. For example, the plurality of upper-end ribs 132 may deform the upper end surface of the target member preventing rotation of the rivet nut relative to the target member.

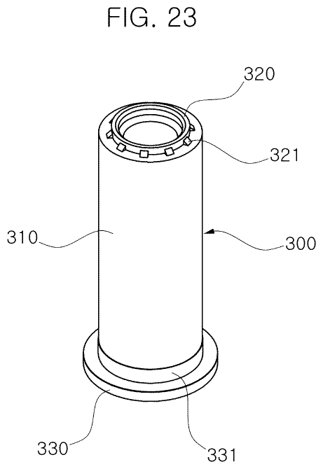

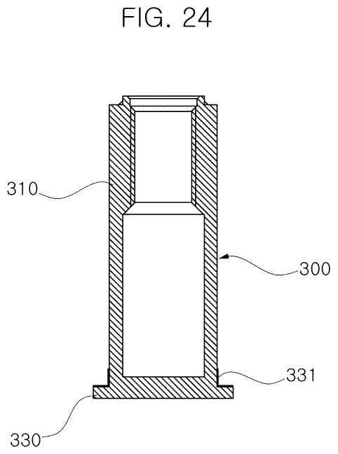

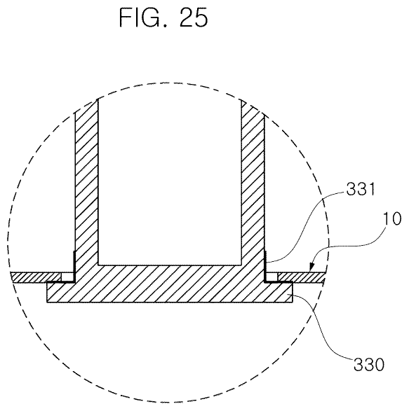

FIG. 23 is a perspective view illustrating a rivet nut 300 according to a fourth embodiment of the present disclosure. FIG. 24 is a cross-sectional view illustrating the rivet nut 300 in FIG. 23. FIG. 25 is a partially enlarged view illustrating the rivet nut 300 in FIG. 23.

The rivet nut 300 in FIG. 23 may include a cylindrical body 310, a protrusion 320, and lower-end ribs 321. The plurality of lower-end ribs may protrude from a lower-end surface of the cylindrical body and an outer surface of the protrusion.

The flange 330, as illustrated in FIGS. 24 and 25, may be formed to have a structure that covers a through-hole. Accordingly, the rivet nut 300 has a watertight structure that prevents moisture from penetrating into the rivet nut 300.

Moreover, a sealing substance, such as, a sealing paint formed of a Teflon material (PTFE) is applied to the lower-end surface of the flange 330 and an outer surface of the upper end portion of the cylindrical body 110. Thus, the rivet nut 300 has the watertight structure that prevents moisture from penetrating between the target member and the flange 330.

With the rivet nut according to the present disclosure and the rivet nut assembly system including the rivet nut according to the present disclosure, when the target member is assembled, for example when the rivet nut is coupled to the target member, the rivet nut is secured to the upper and lower surfaces of the target member with a maximized fixation force. Moreover, according to the present disclosure, it is possible to compensate for tolerance in dimensions of the upper and lower surfaces of the target member and to assemble the target member without the need for machining a conical protrusion (dome) (e.g., in the target member).

Embodiments of the present disclosure are described above with reference to the accompanying drawings. However, the present disclosure is not limited to the described embodiments. It should be apparent to a person of ordinary skill in the art that various modifications and alterations of the described embodiments may be made within a scope that does not depart from the nature and gist of the present disclosure. Embodiments including the resulting modification or alteration fall within the scope of the claims of the present disclosure. The scope of the present disclosure

What is claimed is:

1. A rivet nut in which a through-hole is formed, a target member being assembled with the rivet nut passing therethrough, the rivet nut comprising:
a cylindrical body;
a protrusion formed on and protruding axially from a lower end of the cylindrical body; and
a flange formed on and protruding radially from an upper end of the cylindrical body,
wherein the target member and the rivet nut are assembled by the flange contacting an upper-end surface of the target member and the protrusion contacting a lower-end surface of the target member.

2. The rivet nut of claim 1, further comprising:
a plurality of lower-end ribs protruding from a lower-end surface of the cylindrical body and an outer surface of the protrusion.

3. The rivet nut of claim 2, wherein, when the target member and the rivet nut are assembled by the protrusion contacting the lower-end surface of the target member, the plurality of lower-end ribs press against the lower-end surface of the target member.

4. The rivet nut of claim 1, wherein a rivet is formed on an upper end portion of the cylindrical body, the rivet having a diameter that is greater than a diameter of the cylindrical body, but smaller than a diameter of the flange.

5. The rivet nut of claim 1, further comprising:
a plurality of upper-end ribs protruding from a lower-end surface of the flange and an outer surface of the cylindrical body.

6. The rivet nut of claim 1, wherein the flange is formed in a manner that covers the through-hole.

7. The rivet nut of claim 6, wherein a sealing substance is applied to a lower-end surface of the flange and an outer surface of an upper end portion of the cylindrical body.

8. A rivet nut assembly system comprising:
the rivet nut of claim 1;
a fixation tool for supporting a lower end portion of the rivet nut; and
a punching tool for pressing against an upper end portion of the rivet nut.

9. The rivet nut assembly system of claim 8, wherein the fixation tool includes a body and a groove, wherein the protrusion of the rivet nut can seat in the groove, and wherein the groove has a shape of a ring in an upper-end surface of the body.

10. The rivet nut assembly system of claim 9, wherein a tool protrusion is formed on and protrudes from the upper-end surface of the body of the fixation tool adjacent to and radially inward of the groove.

11. The rivet nut assembly system of claim 10, wherein the tool protrusion has an inclined outer surface such that the tool protrusion has a diameter that gets smaller toward an upper end thereof.

12. The rivet nut assembly system of claim 11, wherein, when the punching tool can press against the rivet nut in a state where the fixation tool supports a lower surface of the target member, the protrusion is deformed in a bent manner along the inclined outer surface of the tool protrusion, and thus the target member is assembled by the tool protrusion contacting the lower-end surface of the target member.

13. The rivet nut assembly system of claim 12, wherein the rivet nut further comprises:
a plurality of lower-end ribs protruding from a lower-end surface of the cylindrical body and an outer surface of the protrusion.

14. The rivet nut assembly system of claim 12, wherein a body of the fixation tool is configured to have a lower cylindrical sub-body and an upper conical sub-body.

15. The rivet nut assembly system of claim 12, wherein the punching tool includes a body and a lower-end groove, wherein the flange of the rivet nut can be received in the lower-end groove, and wherein the lower-end groove is in a lower-end surface of the body of the punching tool.

16. The rivet nut assembly system of claim 12, further comprising:
a first deformation prevention support insertable into the target member, an upper surface thereof configured to contact a lower surface of an upper end portion of the target member, a lower surface thereof configured to contact an upper surface of a lower end portion of the target member, and a first-through groove being formed in one side of the first deformation prevention support in a manner that extends there along from top to bottom; and
a second deformation prevention support insertable into the target member, an upper surface thereof configured to contact the lower surface of the upper end portion of the target member, a lower surface thereof configured to contact the upper surface of the lower end portion of the target member, and a second through-groove being formed in an opposite side of the second deformation prevention support, configured to face the one side of the first deformation prevention support and in a manner that extends there along from top to bottom,
wherein the target member has a tubular shape.

17. A rivet nut assembly method that uses the rivet nut assembly system of claim 16, the method comprising:
arranging the inclined outer surface of the tool protrusion of the fixation tool in such a manner as to be inserted into a lower-end hole formed in the lower end portion of the target member;
arranging the rivet nut by being inserted through an upper-end hole formed in the upper end portion of the target member in such a manner that the protrusion is seated in the groove in the fixation tool; and
pressing against an upper-end surface of the rivet nut by pushing down the punching tool.

18. The rivet nut assembly method of claim 17, wherein, in pressing against the upper-end surface of the rivet nut, the fixation tool presses against a lower-end surface of the target member, deforming the protrusion in a bent manner along the inclined outer surface of the tool protrusion, and whereby the target member is assembled by the protrusion contacting the lower-end surface of the target member and the flange contacting the upper-end surface of the target member.

19. The rivet nut assembly method of claim 18, wherein the rivet nut further comprises:
a plurality of lower-end ribs protruding from a lower-end surface of the cylindrical body and an outer surface of the protrusion,
wherein, in pressing against the upper-end surface of the rivet nut, the lower-end ribs deform the lower-end surface of the target member by pressing thereagainst.

20. The rivet nut assembly method of claim 18, further comprising, before pressing against the upper-end surface of the rivet nut:
inserting the first deformation prevention support and the second deformation prevention support into the target member in such a manner that the first through-groove in the first deformation prevention support and the second through-groove in the second deformation prevention support face each other.
